(19) United States
(12) Patent Application Publication
(10) Pub. No.: US 2024/0235700 A1
(43) Pub. Date: Jul. 11, 2024

(54) METHOD AND APPARATUS FOR SIMULATING MIMO- TYPE WIRELESS CHANNELS EXHIBITING NON- SEPARABLE CROSS-PAS FUNCTION

(71) Applicant: CENTRO DE INVESTIGACIÓN Y DE ESTUDIOS AVANZADOS DEL INSTITUTO POLITECNICO NACIONAL, Zapopan (MX)

(72) Inventor: Ramón PARRA MICHEL, Zapopan (MX)

(73) Assignee: CENTRO DE INVESTIGACIÓN Y DE ESTUDIOS AVANZADOS DEL INSTITUTO POLITECNICO NACIONAL, Zapopan (MX)

(21) Appl. No.: 18/539,494

(22) Filed: Dec. 14, 2023

(30) Foreign Application Priority Data
Dec. 14, 2022 (MX) MX/A/2022/016130

(51) Int. Cl. H04B 17/00; H04B 7/0413

(52) U.S. Cl. CPC H04B 17/0087; H04B 7/0413

(57) ABSTRACT

An apparatus and method of simulating MIMO-type wireless channels exhibiting non-separable cross-PAS function comprising performing a convolution of the input signal with a correlated channel matrix that enables reproducing channel simulations with statistics including CCBBLE while representing a reduction in the required computational complexity.

### CROSS-REFERENCE TO RELATED APPLICATIONS

The present application claims priority to Mexican Patent Application No. MX/a/2022/016130, filed with the Mexico Patent Office on Dec. 14, 2022, the disclosure of which is hereby incorporated herein by reference in its entirety.

The present invention is related to the field of telecommunications; specifically with the implementation of MIMO (Multiple-input Multiple-Output) channel simulators/emulators with non-separable Cross-PAS function. This development will allow testing wireless communication systems or devices based on MIMO schemes in a more reliable and realistic way.

### FIELD OF THE INVENTION

The constant search for the improvement of protocols and data communication schemes, due to the growing and massive demand by users of voice, data and video services, creates the need for devices capable of performing the evaluation and validation of new communications systems in order to help their early market launch. In data communication systems (wired and wireless), this responsibility falls on testing and validation tools such as channel simulators, which seek to simulate the propagation conditions of a communications channel. In this context, the term simulator refers to a software or programming technology implementation, while the term emulator refers to a hardware or physical implementation.

Current multiple-input multiple-output (MIMO) channel models express the channel in terms of orthogonal functions by expanding the spatial domain at the transmitter and receiver in separate ways; the models differ only in the chosen bases and their coupling weights. This approach has facilitated channel capacity analysis and spatiotemporal coding research. However, these models have failed to adequately represent the important case of channels with cross-correlation between both end-links (CCBBLE from Cross-Correlation Between Both Link-Ends). In this development, a theoretical formulation and apparatus configured to build an infinite set of bases suitable for the representation of a MIMO channel is presented, where the models found from the State of the Art are particular cases of the solution presented in this invention. This novel method provides models capable of reproducing channel simulations with predefined or desired second-order statistics including CCBBLE, while providing a decrease in computational complexity. Likewise, a new MIMO channel model is presented as a solution to the methodology proposed in this development. The proposed methodology is validated by means of analytical formulas and simulation results, showing that past models achieve performances similar to those of the Kronecker model, while the methodology proposed in this invention truly provides a model capable of representing realistic channels.

Today, the trend in wireless communication standards is to use MIMO systems because of the high channel capacity, which is theoretically achieved by such systems. Also, MIMO systems in combination with space-time codes provide flexibility to select a trade-off between high data rates and high data protection, depending on the code employed. However, these prominent results consider a propagation environment rich in scatterers, and special configurations in antenna topologies, which together form a spatially white channel, in which the links formed between each transmitting antenna and each receiving antenna are all decorrelated. But measurements of the spatial channel statistics presented in various survey campaigns and practical antenna arrays lead to the conclusion that these previous assumptions are unrealistic: the channel is spatially correlated, and the predicted capacity and diversity of the channel are very optimistic. This has motivated research in the area of MIMO channel modeling, but with certain restrictions: one must provide expressions where the generated channel realizations agree with the desired statistics, and at the same time these expressions are suitable for applications in other areas, such as recoding and space-time coding. This invention focuses on the modeling and simulation of Rayleigh MIMO channels with multipath, narrowband and spatial CCBBLE, while considering the issues mentioned above.

Two different approaches are mainly used to model and simulate MIMO channels. The first one aims to physically reproduce the multipath scenario and is based on the measurement or calculation of the angular power spectral densities. In particular, considering only azimuthal propagation and uncorrelated scattering conditions, the propagation scenario can be statistically described in terms of the Cross Power Azimuth Spectrum (cross-PAS). Given this cross-PAS function, in the conceptualization of channel simulators one can associate the cross-PASs with probability density functions (PDFs), and provide channel realizations by defining group of trajectories whose angles of departure (AoD) and angles of arrival (AoA) follow predefined angular statistics. Other studies are based on the idea of reducing the cross-PAS to a smaller number of identifiable trajectories, and provide channel realizations by generating the parameters for each predefined trajectory. In general, this (physical) approach is mainly used to generate channel realizations, but is not associated with space-time coding research.

The second approach is established with the consideration of assuming the MIMO channel matrix as Gaussian and having the knowledge of the statistics of the Cross Correlation Matrix (CCM). Thus, a CCM function can be calculated from the antenna network topology and the cross-PAS of a given scenario propagation. This consideration allows to easily produce MIMO channel simulations through the well-known Karhunen-Loève expansion (KLE) method. However, although the KLE method is sufficient to reproduce the channel realizations without error and requiring the minimum number of Gaussian generators, the method is not commonly used in channel modeling because it clouds the channel structure information, obscuring the capability and diversity of analysis, which requires information provided by the eigenvalues of the one-way Channel Correlation Matrices (CCMs). Therefore, the channel modeling area has preferred to consider expressions that use the CCM as well as CCMs at the transmitter (Tx) and/or at the receiver (Rx), referred to as CCM^{Tx(Rx)} for the case Tx(Rx), resulting in channel models expressed in simpler ways and requiring fewer parameters, even though they are important in MIMO systems research. For example, the MIMO channel model on the transmitter side Tx in terms of CCM eigenfunctions^{Tx} allows the use of signal focusing (Beamforming) in applications and reduced range MIMO channel estimation. For these reasons, it can be established that models based on one-way CCMs are suitable for research in signal processing algorithms focused on MIMO systems.

Regarding channel statistics, initial studies consider the decorrelation between the transmitter Tx and the receiver Rx, where the Kronecker product of one-way CCMs adequately represents the CCM, however, this consideration is not sufficient to deal with realistic channels. Real channels present CCBBLE characteristics, so their correct modeling generates a great impact on research in several areas related to MIMO schemes. There are several contributions which represent an attempt to deal with this general case, but these attempts correspond to models belonging to the second approach, which can be related to the first approach by conceiving them as “artificial trajectories”, where the multipaths are represented on each side of the link, both transmitter and receiver, as a set of complex trajectories, in order to reduce their number when compared to the physical propagation trajectories. The CCBBLE is introduced in the models through coupling weights between each artificial path on the transmitter side Tx and each artificial path on the receiver side Rx. Other models use discrete exponential sequences as artificial trajectories (called “virtual paths”), while some models consider eigenfunctions of the one-way CCM correlation, and Discrete Prolate Spheroidal Sequences (DPSS), respectively, as well as artificial trajectories in the spatial domain.

In this regard, U.S. Pat. No. 9,686,702 B2 discloses a channel emulator for testing network resources comprising generating channel realizations (simulations) by determining a correlator matrix and factors for covariance matrices, however, it does not contemplate performing a convolution of the input signal with the channel matrix, such as in the invention claimed herein.

Document EP 3 672 094 A1 discloses a channel modeling method for a MIMO system configured to establish a channel model by means of a correlation between transmitting antenna elements, receiving antenna elements and a channel matrix between the transmitting and receiving antenna arrays, which represents one of the main objectives to be solved by the invention, which only requires the input of an input signal, corresponding to the transmitting antenna elements (Tx), without the need to consider the signal from the receiving antenna elements, which reduces the computational complexity of the system. However, none of these previous proposals has been able to reproduce the desired channel statistics considering CCBBLE in a satisfactory manner, until the present invention. Furthermore, there is no technical background where the requirements to generalize the construction of models for channel representation, or the true performance (when compared to the optimal approximation of the KLE method) of their proposed models, have been established. Moreover, the performance of the models in reproducing the original propagation scenario (in terms of the cross-PAS objective function) has yet to be discussed. Solutions to all these open questions are presented in this invention. The solution is based on the orthogonal expansion of the random channel technique, which was used by the author in “Simulation of wide band channels with non-separable scattering functions,” in Proc. IEEE Int. Conf. on Acoustics, Speech, and Signal Process to model and simulate SISO channels with non-separable scattering functions.

### BACKGROUND OF THE INVENTION

The narrowband communication system under consideration is composed of a set of N antennas on the transmitting side and a set of M antennas on the receiving side. This input-output relationship of the systems can be expressed in its complex-lower representation as:

y=Hx+n, (1)
where y is a vector of size M×1 of the received signals while x is the vector of size N×1 of the transmitted data per channel used. H is a matrix of size M×N whose components h_{m,n}={H_{m,n}} denote the complex fading gains between the n-th transmitting antenna and them m-th receiving antenna. This model only considers the spatial characterization of the channel; time domains will be left aside in this development. Finally, n represents a vector of size M×1 of complex-valued additive white Gaussian noise (AWGN) variables, which is always found in any electrical device today. Considering that the underlying propagation phenomenon is rich in scatterers, each component h_{m,n} of H is modeled as a complex Gaussian random variable with variance per dimension equal to 0.5. For this channel, all statistics required to fully characterize it are only second-order statistics. Expanding H in its vector form with:

h=vec(H), (2)

the CCM Rₕ can be calculated with:

Rₕ=E{hh^{H}} (3)

This matrix contains the channel statistical information, which is implicitly associated in particular with a multipath propagation scenario. However, the propagation channel statistics are not usually given in terms of CCMs, but in terms of Cross-PASs. Therefore, in this case it is mandatory to understand the connection between these two expressions. It is important to note that in this invention, the discussion will focus on explaining the computation (ratio) of Rₕ according to some propagation environments whose statistics are given in angular domains. The next subsection deals with a method for providing realizations of H that exhibit the desired statistics, which is the main focus of this contribution.

### Cross-PAS Information

The most intuitive model for spatial characterizations of the channel can be explained with the help of FIG. 1, which considers a single output path from a linear array of antennas and the received signal being measured also by a linear array of antennas, both arrays located along the axis ŷ on their respective side of the communication link.

In FIG. 1, \vec{r}_{Tx(Rx),0} is a reference point in space at the link ends Tx(Rx) while \vec{k}_{TX(Rx),l} is the l-th path wave vector, which points to the outgoing (and incoming) direction of the path, respectively. Considering only the azimuthal angle in the propagation scenario, the Angular Dependent Channel Impulse Response (ADCIR) c(φ_{Tx};φ_{Rx}), also known as the spatial dual-directional channel model (considering only the angular variables), is simply defined as:

$$c ( {φ}_{Tx} ; {φ}_{Rx} ) = {\sum }_{l - 1}^{L} {α}_{l} δ ( {φ}_{Tx} - {φ}_{Tx , l} ) δ ( {φ}_{Rx} - {φ}_{Rx , l} ) . \qquad ( 4 )$$

The ADCIR model is expressed as a sum of l=1, 2, . . . , L main complex trajectories, which depart from the Tx side and arrive at the Rx side. In addition, this model characterizes the channel propagation between two locations near the reference points in space \vec{r}_{Tx,0} and \vec{r}_{Rx,0} On the other hand, Tx(Rx) is the azimuthal angular variable on the Tx(Rx) side of the link respectively, while φ_{Tx,l} and φ_{Rx,l} represent the azimuthal angle AoD (Angle of Departure) and angle AoA (Anglel of Arrival) of the l-th trajectory, respectively. The angles are measured in radians and are considered positive when going counterclockwise, with the value of 0 radians corresponding to the \hat{x} axis. According to (4), each main path is weighted by a complex gain αₗ, which results from the integration of all the physical waves that have left the transmitter with the angle φ_{Tx,l} and after passing through scatterers, arrive at the receiver with the angle φ_{Rx,l·}. Thus, the complex gain αₗ includes a sum of multiple waveforms, resulting in the modeling of αₗ as a complex Gaussian random variable. It is important to note that in several scenarios, the multiple trajectories are fuzzy, and therefore L can be considered infinite. In this case, the sum in (4) should be replaced by integrals for each of the angles involved. To facilitate the reading of the results presented in this invention, the model used considers a finite number of trajectories, and the derivations of this model will only consider this case; however, it should be kept in mind that the methodology introduced also works for the case of the channel with fuzzy trajectories.

For the Uniform Linear Arrays (ULAs) considered in this invention, the interest lies in the evaluation of the spatial channel in the antenna location. From FIG. 1 and considering the Tx case (the same applies to the end of Rx), the phase difference between then n-th antenna of the array located at the space point \vec{r}_{Tx,n}, with respect to the reference point (location of the first antenna) for the l-th path, is e^{j\vec{k}}^{_{Tx,l}}^{·\vec{r}T}^{_{x,n}}; where, \vec{r}_{Tx,n}=(n−1)d_{Tx}ŷ \vec{k}_{Tx,l}=k₀(cos(φ_{Tx,l})\hat{x}+sin (φ_{Tx,l})ŷ) and

$${k}_{0} = \frac{2 π}{λ}$$

is the wavenumber of the free space of a single wavefront; λ is the wavelength of the path and d_{Tx} is the spacing between elements. Thus, including the phase difference of all antennas in the ULA array (with respect to the reference point) in one vector results in an AMV vector (Array Manifold Vector) on the Tx side of the link, denoted as v_{Tx,l}, which results in the following expression for the antenna array topology being considered:

$${v}_{Tx , l} = {[ 1 , {e}^{{jk}_{0} {d}_{Tx} si n ( {φ}_{Tx , l} )} , … , {e}^{{jk}_{0} {d}_{Tx} ( N - 1 ) si n ( {φ}_{Tx , l} )} ]}^{T} , \\ {v}_{Rx , l} = {[ 1 , {e}^{{jk}_{0} {d}_{Rx} si n ( {φ}_{Rx , l} )} , … , {e}^{{jk}_{0} {d}_{Rx ,} ( M - 1 ) si n ( {φ}_{Rx , l} )} ]}^{T} ; \qquad ( 5 )$$

where v_{Rx,l} is the AMV for the l-th trajectory on the Rx side and d_{Tx(Rx)} is the spacing between elements in the matrix Tx(Rx), respectively. The exponentials in the last equation can be considered positive (phase advance) for the trajectory depicted in FIG. 1 and for the Tx case, but negative (phase delay) for the given Rx case. But trajectories arriving with angles in the interval π≤φ_{Tx(Rx),l}<2π, result in the opposite case. However, the same case occurs if the reference point is located at the opposite end of the array. So due to its ambiguity, some studies consider only positive exponential values while others consider only negative ones. Therefore, without loss of generality due to the involved randomness of the considered trajectories (and due to the fact that their choice leads us to expressions conforming to the correct transformation within the spatial and wavenumber domains), in this invention the AMVs as defined by equation (5) will be used.

Using the MVA at each end of the communications link, the equation connecting the channel realizations, in the angle domain, to the channel simulations of the MIIMO system channel with a particular antenna topology is defined as:

$$H = {\sum }_{l - 1}^{L} {α}_{l} {v}_{Rx , l} {v}_{Tx , l}^{T} . \qquad ( 6 )$$

To obtain the MCC from the previous expression, the associated angular statistics are required. Thus, taking the autocorrelation function from (4) produces a four-dimensional function S_{c}(•) as follows:

S_{c}(φ_{Tx},ϕ_{Tx};φ_{Rx},ϕ_{Rx})=E{c(φ_{Tx};φ_{Rx})c*(ϕ_{Tx};ϕ_{Rx})}, (7)

where ϕ_{Tx} and ϕ_{Rx} are auxiliary variables corresponding to the azimuthal angle. This four-dimensional autocorrelation function is too complex to be manipulated, and its information is difficult to obtain. The channel can be considered for various scenarios as a channel with decorrelated scattering in the angle domains, therefore the latter expression can be expressed in terms of fewer variables in the following method:

S_{c}(φTx,ϕ_{Tx};φ_{Rx},ϕ_{Rx})=P(φ_{Tx};φ_{Rx})δ(φ_{Tx}−ϕ_{Tx})δ(φ_{Rx}−ϕ_{Rx}). (8)

Thus, (7) can be fully represented by a two-dimensional function, widely known as the cross-PAS, P(φ_{Tx};φ_{Rx}), which specifies the PAS on the Rx side produced by each output path on the Tx side. Thus, it is evident that the cross-PAS spectra represent propagation environments, and that they can be obtained from measurement campaigns, geometrical models or even user-defined functions for performance evaluation of communication systems. For the ADCIR of a number of finite paths discussed here, the cross-PAS is expressed as:

$$P ( {φ}_{Tx} ; {φ}_{Rx} ) = {\sum }_{l = 1}^{L} {σ}_{l}^{2} δ ( {φ}_{Tx} - {φ}_{Tx , l} ) δ ( {φ}_{Rx} - {ϕ}_{Rx , l} ) . \qquad ( 9 )$$

In (9), σₗ²=E{αₗαₗ*} is the variance of the l-th trajectory and E{αₗαₗ}=0 for l′≠l, where l′ represents an auxiliary indexing variable; i.e., the trajectories are decorrelated. It is important to note that with the decorrelation assumption, realizations of H are easily produced by generating complex random variables with variance according to the corresponding trajectory, and then using expression (6). However, this approach (in the physical sense) is inappropriate when the number of trajectories considered is high and the number of antennas involved is low. In such cases, other methods, such as those presented in the next section, should be considered.

A simplification of the cross-PAS can be obtained by considering the PAS on each side of the communication link, here referred to as the simplified one-way PAS spectrum, P_{Tx(Rx)}_{ₛᵢₘₚ}(φ_{Tx(Rx)}), for Tx(Rx) respectively, which is easily obtained by integrating the cross-PAS along the angular variable of no interest:

$${p}_{{Tx ( Rx )}_{simp}} ( {φ}_{Tx ( Rx )} ) = {\int }_{- π}^{π} P ( {φ}_{Tx} ; {φ}_{R x} ) d {φ}_{Rx ( Tx )} , \qquad ( 10 )$$

Hence, for the propagation model considered, we have:

$${p}_{{Tx}_{simp}} ( {φ}_{Tx} ) = {\sum }_{{l}_{1} = 1}^{{L}_{1}} {σ}_{{l}_{1}}^{2} δ ( {φ}_{Tx} - {φ}_{Tx , {l}_{1}} ) , \\ {P}_{{Rx}_{simp}} ( {φ}_{Rx} ) = {\sum }_{{l}_{2} = 1}^{{L}_{2}} {σ}_{{l}_{2}}^{2} δ ( {φ}_{Rx} - {φ}_{Rx , {l}_{2}} ) , \qquad ( 11 )$$

where l₁4=1,2, . . . , L₁, l₂=1,2, . . . , L₂ being defined L₁ and L₂ as the numbers of trajectories with different angles at the Tx and final Rx s, respectively. In addition, σₗ_{₁}² and σₗ_{₂}² correspond and to the difference of each of the trajectories involved. Note that (11) always satisfies L₁, L₂≤ L, with equality holding when no trajectory in the component variable has the same angle for the independent variable in (10). Thus, for a lossless channel, it is common to normalize the cross-PAS as Σₗ₌₁^{L}σₗ²=1.

Under separability conditions, i.e., when the fading statistics of transmitters and receivers are independent, the separable xPAS spectrum Pₛₑₚ(φ_{Tx};φ_{Rx}) can be expressed as an outer product of two PASs spectra, P(φ_{Tx(Rx)}) one-dimensional, as shown below:

Pₛₑₚ(φ_{Tx};φ_{Rx})=p(φ_{Tx})P(φ_{Rx}). (12)

However, according to measurement campaigns this condition is not commonly encountered in realistic propagation environments, but it reduces the need to have data for a full cross-PAS spectrum, so then, it can be easily constructed from the information only a one-way PAS.

### Correlation of Cross-PAS Information Channel

Using the definition of h from (2) and with H expressed as in (6), it results in

$$h = {\sum }_{l = 1}^{L} {α}_{l} ( {v}_{Tx , l} ⊗ {v}_{Rx , l} ) . \qquad ( 13 )$$

From (13), the CCM of the MIMO channel defined as (3) results in

$$\begin{matrix}{R }_{h} = {\sum }_{l = 1}^{L} {σ}_{l}^{2} ( {v}_{Tx , l} ⊗ {v}_{Rx , l} ) {( {v}_{Tx , l} ⊗ {v}_{Rx , l} )}^{H} , \\ = {\sum }_{l = 1}^{L} {σ}_{l}^{2} ( {v}_{Tx , l} {v}_{Tx , l}^{H} ) ⊗ ( {v}_{Rx , l} {v}_{Rx , l}^{H} ) .\end{matrix} \qquad ( 14 )$$

For the second line of equation (14), use has been made of the properties of the Kronecker product (a⊗b)(c⊗d)=(ac)⊗(bd) and (a⊗b)^{H}=a^{H}⊗b^{H}. It is observed that once any cross-PAS is given, its corresponding CCM is easily extracted by making use of (14). On the other hand, for the one-way PAS p(φ_{Tx(Rx)}) the corresponding one-way CCM correlation R_{Tx(Rx)} can be calculated with:

$${R}_{Tx} = {\sum }_{{l}_{1} = 1}^{{L}_{1}} {σ}_{{l}_{1}}^{2} {v}_{Tx , {l}_{1}} {v}_{Tx , {l}_{1}}^{H} , {R}_{R x} = {\sum }_{{l}_{2} = 1}^{{L}_{2}} {σ}_{{l}_{2}}^{2} {v}_{Rx , {l}_{2}} {v}_{Rx , {l}_{2}}^{H} . \qquad ( 15 )$$

For the separable cross-PAS in (12), a special case occurs that results in its corresponding xCCM, R_{h,sep}, being expressed in terms of two one-way CCMs, as follows:

R_{h,sep}=R_{Tx}⊗R_{Rx}. (16)

### BRIEF DESCRIPTION OF THE INVENTION

This application presents a method and apparatus for constructing an infinite set of bases suitable for simulation of a MIMO channel, wherein the models found from the state of the art are particular instances of the solution presented in this invention. This novel framework provides models capable of reproducing the desired second-order channel realizations, with statistics including CCBBLE, while decreasing the computational complication. A solution of the given methodology is represented here as a new MIMO channel model. This proposed technique is validated by analytical formulas and simulation results, showing that past models achieve performances similar to those of the Kronecker model while the methodology proposed in this application truly provides a model that is capable of representing real channels.

### SUMMARY OF THE INVENTION

In order to overcome the problems existing in the aforementioned prior art, the present description provides a method and simulator for MIMO-type wireless channels exhibiting non-separable cross-PAS function, as will be described below.

A first objective of the present invention consists in providing a MIMO-type wireless channel simulator exhibiting non-separable cross-PAS function comprising: a controller module configured to perform control of each of the simulator modules; a coefficient generator module configured to perform generation of coefficients CoefΛ_{Rb}_{_{λ}} and Coefg_{K}_{_{λ}}, and base functions Φ and Γ; a weight generator module βₖ configured to generate weights βₖ using the coefficients CoefΛ_{Rb}_{_{λ}} and Coefg_{K}_{_{λ}} received from the coefficient generator module; a correlator matrix generator module configured to perform the expansion of a matrix H from the matrix multiplication of the basis functions Φ and Γ received from the coefficient generator module with the weights βₖ received from the weight generator module; and a convolution module configured to perform a convolution of the input signal x_{1,2, . . . ,N}(nTₛ) with the H channel matrix generated by the correlator matrix generator module.

A second objective of the present invention consists in providing the method of simulating MIMO-type wireless channels exhibiting non-separable cross-PAS function, comprising the steps of: generating coefficients CoefΛ_{Rb}_{_{λ}} and Coefg_{K}_{_{λ}}, and base functions Φ and Γ using a coefficient generator module; generating weights βₖ from the coefficients CoefΛ_{Rb}_{_{λ}} and Coefg_{K}_{_{λ; performing the expansion of an H matrix from the matrix multiplication of the base functions Φ and Γ received from the coefficient generator module with the weights β}}ₖ received from the weight generator module; and convolving the input signal x_{1,2, . . . ,N}(nTₓ) with the expanded H channel matrix.

### BRIEF DESCRIPTION OF THE FIGURES

To give a better understanding of the invention, a description of the invention is provided below together with accompanying drawings, in which:

FIG. 1 shows the antenna topology of a MIMO communication system and the propagation of the scenario depicted in terms of multiple paths.

FIG. 2 shows the cross-correlation between artificial weights of the PM method.

FIG. 3 shows the architecture of the MIMO Channel Simulator with Cross-PAS Non-Separable.

FIG. 4 shows the architecture of the coefficient generator module and functions of the MIMO channel simulator.

FIG. 5 shows the weight generator module of the MIMO channel simulator.

FIG. 6 shows the cross-PAS reconstructed from the original CCM cross-correlation matrix.

FIG. 7 shows the cross-PAS reconstructed from the MCC produced by the model proposed in this invention.

FIG. 8 shows the cross-PAS reconstructed from the CCM correlation matrix produced by the Weich model.

FIG. 9 shows the cross-PAS reconstructed from the CCM correlation matrix produced by Sayeed's model.

FIG. 10 shows the cross-PAS reconstructed from the CCM correlation matrix produced by the Kron model.

FIG. 11 shows the cross-PAS reconstructed from the CCM correlation matrix produced by the Kont model.

FIG. 12 shows the cumulative distribution function of the channel capacity CDF(C) of the compared models as a result of the simulation for Channel I.

FIG. 13 shows the cumulative distribution function of the CDF(C) channel capacity of the models compared as a result of the simulation for Canal II.

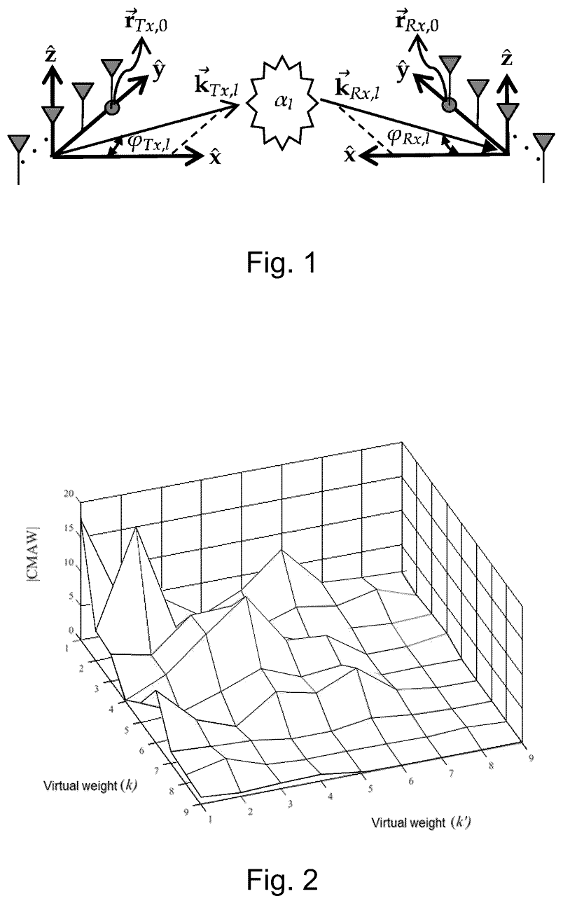

Generation of MIMO Channel Realizations (Simulations) with Predefined Second-Order Statistics

### Direct Use of the KLE Method

KLE allows Rₕ to be represented as Rₕ=UΛ_{R}_{ₕ}U^{H}, where U is a matrix of eigenvectors uₖ, i.e. U={u₁, u₂, . . . , u_{NM}}, and Λ_{R}_{ₕ} is a matrix containing the corresponding eigenvalues on its diagonal, i.e. diag(Λ_{R}_{ₕ})={λ₁,λ₂, . . . ,λ_{NM}}^{T}, arranged in decreasing order of energy. The KLE eigenvectors can be used to generate realizations of the channel according to h=U|\sqrt{diag(Λ_{R}_{ₕ})}εg_{MN}) where g_{MN}={g₁,g₂, . . . ,g_{MN}}^{T} is a vector of size MN of complex Gaussian random variables gₖ's, all independent and identically distributed (i.i.d.) with variance by dimension equal to 0.5. The properties of eigenvectors and eigenvalues of correlation matrices of Gaussian processes are well known so they will not be discussed further. So it is sufficient to recall here that in correlated processes, one can select a reduced number K_{λ} of eigenvectors that carry most of the energy of the process, and thus can be used to expand the realizations of the channel with as low an error as desired. This reduction in the number of eigenvectors used also offers a reduction in computational complexity because fewer Gaussian generators are required. When this important subset of eigenvectors and eigenvalues are included in the matrices Uₖ_{_{λ}} and Λ_{R}_{ₕ}_{·k}_{_{λ}}, respectively, a reduced expression for the KLE-based channel model in vector form is h_{KL}=U_{K}_{_{λ}}(diag(Λ_{R}_{ₕ}_{,K}_{_{λ}})εgₖ_{_{λ}}) The same modeling expressed as a linear combination of heavy eigenvectors is defined as:

$${h}_{K L} = {\sum }_{k = 1}^{{K}_{λ}} {c}_{k} {u}_{k} , \qquad ( 17 )$$

where k is the index variable, cₖ=\sqrt{λₖ}gₖ and gₖ_{_{λ}} is a vector similar to g_{MN} but of size of K_{λ}. This is the only previous model capable of providing channel realizations with the exact desired statistics and with predefined error, but is avoided for the reasons mentioned in the background section of the invention.

### A Methodology for MIMO Channel Model Generation and a Particular Solution as the Proposed Channel Model.

The general expression of the proposed model (PM) for the realizations of the channel in vector form is

$${h}_{P M} = {\sum }_{k = 1}^{K} {β}_{k} {z}_{k} , \qquad ( 18 )$$

where zₖ also represents the basis functions for the channel representation, but in contrast to (17), they are not obtained from functions of Rₕ and their weights βₖ are Gaussian variables that are generally correlated with each other. Likewise, the number of A functions required to achieve a given error will generally be larger than K_{λ}. However, the required independent Gaussian generators are actually the same in both cases. The following section shows the derivation of the proposed methodology under discussion.

It is well known that an infinite set of MN basis functions can be formed by approximation h, but how can these bases be designed with the constraint of also being reduced rank? We require these bases to provide a low error in the approximation when (K: K_{λ}<MN); of course, this assumes that the channel is presenting correlation.

Thus, letting qₗ=v_{Tx,l} ⊗v_{Rx,l} and, R_{h,1} Rₕ be represented as R_{h,1}=Σ_{I=1}^{L}σₗ²Qₗσₗ²>0, Rₕ=Σₗ₌₁^{L}ηₗ²Qₗ, ηₗ²≥0, where Qₗ=qₗqₗ^{H} denotes the outer product of a vector qₗ, Rₕ and R_{h,1} are correlation matrices obtained with (14) of some given spectra cross-PAS and cross-PAS¹, respectively. Then it holds that the image of and {Rₕ} {R_{h,1}} are related as the image {Rₕ}⊂image {R_{h,1}}.

This implies that R_{h,1} 's own functions can be used to expand its channel simulations, as well as expand the simulations for a channel that has produced Rₕ. Thus, for a channel with a given cross-PAS having this property, an infinite number of cross-PAS¹ can be designed simply by being sure that in them one has energy for any existing trajectory in the cross-PAS to be approximated.

On the other hand, let a correlation function Rₕ be obtained from a channel h expressed as in (4) with cross-PAS P(φ_{Tx},φ_{Rx}), and let R_{h,1} be obtained from a cross-PAS¹ in the following way: P₁(φ_{Tx},φ_{Rx})=P_{Tx}_{ₛᵢₘₚ} (φ_{Tx}) P_{Rx}_{ₛᵢₘₚ} (φ_{Rx}), i.e., the outer product of the simplified one-way PAS obtained through (10) with P(φ_{Tx},φ_{Rx}). Then, it holds that the eigenfunctions of R_{h,1} expand the channel h realizations.

These considerations allow the problem of channel h simulations to be presented from the point of view of reduced-rank random spaces. Starting with a cross-PAS and forming R_{h,1}, it follows from (16) R_{h,1}=R_{Tx}⊗R_{Rx}, where R_{Tx} and R_{Rx} are correlation matrices obtained from a simplified one-way PAS by means of (11) and (15) in the cross-PAS objective. Therefore, their KLE expansion is expressed as R_{h,1}=ZΛ_{R}_{_{h,l}}Z^{H}, where z={z₁,z₂, . . . ,z_{MN}} is a matrix with eigenvectors zₖ and Λ_{R}_{_{h,l}} is the matrix of the associated eigenvalues. Then, it follows that h=Σₖ₌₁^{MN}βₖzₖ, according to (18) when all eigenvectors are used in the approximation (note that the generation of βk's has not been discussed yet). For readability reasons, the same variable k that was used in the direct KLE method has been used to enumerate the vectors in the proposed model. A deeper look into the characteristics of the vectors and weights of this approach reveals that R_{h,1} comes from a separable cross-PAS, and therefore, vectors and eigenvalues of R_{h,l} are simply Kronecker products of the eigenvectors and eigenvalues, respectively, of R_{Tx} and R_{Rx}. Thus the correlation matrices R_{Tx} and R_{Rx} are expanded by means of their KLE expansions as R_{Tx}=ΓΛ_{Tx}Γ^{H}; R_{Rx}=ΦΛ_{Rx}φ^{H}, where Γ={γ₁,γ₂, . . . ,γ_{N}} and Φ={ϕ₁,ϕ₂, . . . ,ϕ_{M}} are matrices of the eigenvectors indexed according to their corresponding energy. It then follows that Z=Γ⊗Φ [21], since h can be expanded in this way:

$$h = {\sum }_{m = 1}^{M} {\sum }_{n = 1}^{N} {β}_{m n} ( {γ}_{n} ⊗ {ϕ}_{m} ) ; \qquad ( 19 )$$

where βₘₙ are the weights required in the approximation that “interconnects” then n-th artificial transmitting path with the m-th artificial receiving path. Allowing for some level of error in this approximation, the use of a subset of the eigenvectors yields the following expression for the proposed models:

$${h}_{P M} = {\sum }_{i = 1}^{I} {\sum }_{j = 1}^{J} {β}_{ji} ( {γ}_{i} ⊗ {ϕ}_{j} ) = {\sum }_{k = 1}^{K} {β}_{k} {z}_{k} , \qquad ( 20 )$$

where i=1, 2, . . . , I, and j=1, 2, . . . , J are indexing variables, while I, and J are the maximum number of eigenvalues in Λ_{Tx} and Λ_{Rx}, respectively, needed to guarantee a predefined error. Likewise, k=1, 2, . . . , K, is an index that enumerates all i,j cases, i.e., K=IJ. Defining a weight matrix such as {Bⱼᵢ}>βⱼᵢ, then, among the different possibilities for the relationship between the values of k and i,j, in the following we consider a columnwise enumeration of the matrix B, i.e., that, where k=(i−1)J+j i, j can be obtained from k using first i=[k÷J] and then j=k−(i−1)J. Therefore, immediately follows which zₖ=(γ_{i=┌k+J}┐⊗ϕ_{j=k-(i-1)I)}.

The generation of the βₖ weights and their statistics is now presented. Each weight βₖ is obtained from the target channel by a simple mapping. Multiplying the rightmost formula of expression (20) by its left-hand side with zₖ^{H}, and recalling their property of being orthonormal due to the fact that they are eigenvectors, results in

zₖ^{H}h⇒βₖ, (21)

and including all values βₖ in a vector bₓ, it follows that

Zₖ^{H}h⇒b_{K}; (22)

where Z_{K} is a matrix with only the first K eigenfunctions significant. It is worth noting here that since a set of eigenfunctions has been used in approximating the channel, the mapping is not a bijective function; that is, multiplying (22) with Z_{K} on its left-hand side will not give h=Z_{K}b_{K}. Instead of an equation, it is an approximation in the form of h≈Z_{K}b_{K}, which is precisely the proposed channel model in its vector form:

h_{PM}=Z_{K}bₖ. (23)

Since the model is not exact, it is worth remembering that its approximation can be as accurate as desired. It is also important to note that the weights of βₖ are correlated random variables. In fact, the correlation between any two weights can be calculated as σₖₖ′=E{βₖβ_{k′}^{H}}, which by making use of (21) leads immediately to:

zₖ^{H}Rₕz_{k′}⇒σ_{kk′}, (24)

where k′=1, 2, . . . , K is an auxiliary indexing variable. Defining a correlation matrix of artificial weights (CMAW) as R_{b}_{_{K}}=E{b_{K}b_{K}^{H}}, it follows from (22) that

Z_{K}^{H}RₕZ_{K}⇒R_{b}_{_{K}}, (25)

with

$${R}_{{b}_{K}} = [ \begin{matrix}{σ}_{11} & {σ}_{12} & … & {σ}_{1 K} \\ {σ}_{21} & {σ}_{22} & … & {σ}_{2 K} \\ ⋮ & ⋮ & ⋱ & ⋮ \\ {σ}_{K 1} & {σ}_{K 2} & … & {σ}_{KK}\end{matrix} ] .$$

Since R_{b}_{_{K}} is a correlation function, it can be expanded in terms of its KLE: thus

$${R}_{{b}_{K}} = {ΘΛ}_{{R}_{{b}_{K}}} {Θ}^{H} ,$$

where Θ and [symbol] are matrices containing eigenvectors and eigenvalues, respectively, of R_{b}_{_{K}}. Selecting again only the eigenvectors Θ in that contribute most of the process energy, then the realization of a random vector b_{K} whose correlation is precisely R_{b}_{_{K}} can easily be presented as follows:

$${b}_{K} = {Θ}_{{K}_{λ}} ( \sqrt{diag ( {Λ}_{{R}_{{b}_{K}} , {K}_{λ}} )} ε {g}_{{K}_{λ}} ) , \qquad ( 26 )$$

where [symbol] contains only the significant eigenvalues of R_{b}_{_{K}}. Note that in (26), the size of g_{K}_{_{λ}} reflects the truly independent (parallel) modes of the expanded channel, and this number is the same as that produced by the direct KLE. This is because (22) is a unitary transform, and therefore both Rₕ and R_{b}_{_{K}} will have the same significant eigenvalues (limited only by the need to select a sufficiently large number K in the PM). From the previous discussion, it follows that simulations of the PM channel in vector form can be provided using (23) and (26). However, insight can be gained by expressing the PM in its matrix form. Devectorizing h_{PM} from (20) with H_{PM}=unvec(h_{PM}, M) yields.

$${H}_{P M} = {\sum }_{i = 1}^{I} {\sum }_{j = 1}^{J} {β}_{ji} {ϕ}_{j} {γ}_{i}^{T} , \qquad ( 27 )$$

And recalling {Bⱼᵢ}=βⱼᵢ, we have an equivalent expression to (27) in terms of matrix operation defined as

H_{PM}=Φ_{J}BΓₗ^{T}, (28)

where Φ_{J} and Γₗ are matrices including only the dominant J and I eigenvectors of Φ and Γ, respectively. Noting that B=unvec(b,J), and combining equations (26) and (28), the channel model proposed here in its matrix form can also be stated as follows:

$${H}_{PM} = {Φ}_{J} [ unvec ( ( {Θ}_{{K}_{λ}} ( \sqrt{diag ( {Λ}_{{R}_{{b}_{K}} , {K}_{λ}} )} ε {g}_{{K}_{λ}} ) , J ) ] {Γ}_{I}^{T} . \qquad ( 29 )$$

This PM model is to be interpreted as a sum of correlated artificial trajectories. Its modes are constructed from one-way CCMs correlation matrices as required, and it is able to reproduce channel realizations with desired second-order statistics with predefined error. As its parameters were connected with the channel statistics provided in terms of the cross-PAS, it is suitable for developing simulators of any scenario, i.e., assuming decorrelation, and also for channel investigation, beamforming or space-time coding. PM provides clear advantages when compared to previous models, as will be clarified in the following sections.

### Relationship of the Proposed Model to Correlation-Oriented Models

Relationship with the KLE method. The KLE method in the form of (29) is

H_{KL}=unvec(U_{K}_{_{λ}}(diag(Λ_{R}_{_{b}}_{,K}_{_{λ}})εg_{K}_{_{λ}}), (30)

A comparison of (29) and (30) reveals that H_{PM} and the KLE model share the same number (and values) of decorrelated weights that the channel exhibits, requiring the generation of the same number of random variables to compute a channel realization, but with different structure and base functions. Likewise, the acquisition of eigenvectors (before having the information to have a subset) has a complexity on the order of (NM)³ for H_{KL}, but for H_{PM}, in which the eigenvectors are Kronecker products of one-way CCMs of smaller size, the complexity is reduced to N³+M³+K³, even below (NM)³ when K is not so far from NM. Finally, H_{PM} is suitable for the investigation of the spatial domain algorithm, and can be explicitly used as a one-way propagation mode.

Relation to Weichselberger's model. In W. Weichselberger, H. Herdin, H. Ozcelik, and E. Bonek, “A stochastic MIMO channel model with joint correlation of both link ends,” IEEE Trans. Wireless Commun. vol. 5, no. 1, pp. 90-100, January 2006, the authors propose a model based on measurements of channel realizations, from which the one-way CCMs R_{B} and R_{A} (for the Tx and Rx end link, respectively) are obtained as follows:

R_{B}=E{H^{T}H*},R_{A}=E{HH^{H}} (31)

Once these CCMs matrices are determined, they are used to provide their own one-way functions A, B, by means of a KLE such as R_{A}=U_{A}Λ_{A}U_{A}^{T}, R_{B}=U_{B}Λ_{B}U_{B}^{T}, and U_{A}={u_{A,1}, u_{A,2}, . . . , u_{A,M}}, U_{B}={u_{B,1}, u_{B,2}, . . . , u_{B,N}}. A matrix of energy coupling weights, Ω, between two modes, u_{B,n}, u_{A,m} is defined as

{Ω_{m,n}}=ω_{m,n}=(u_{B,n}⊗u_{A,m})^{H}Rₕ(u_{B,n}⊗u_{A,m}). (32)

Defining the square root values of Ω (element by element) in a matrix □Ω, the derived parameters define the Weichselberger model, H_{Weich}, which provides channel realizations according to:

H_{Weich}=U_{A}(□ΩεG_{M×N})U_{B}^{T}, (33)

where G_{M,N} is a matrix of M×N of Gaussian i.i.d decorrelated complex variables with variance by dimension equal to 0.5. To understand the relationship of this model for H_{PM}, it is first necessary to reduce the ratios of one-way CCMs obtained through equations (31) and (15), which turned out in the end to be the same, only scaled by one factor; thus one has:

R_{A}=NR_{Rx};R_{B}=MR_{Tx}. (34)

This result immediately leads to the conclusion that U_{A}=Φ and U_{B}=Γ. Defining the quadratic form of the correlation function R_{b,M×N} as

Z^{H}RₕZ⇒R_{b,M×N}, (35)

And then observing the relationship between (32) and (24), it is evident that ω_{m,n}=σₖₖ; in this case. k=(n−1)M+m, and so Ω=unvec(diag(R_{b,M×N}),M). Therefore it can be established that

H_{Weich}=Φ└unvec((\sqrt{diag(R_{b,M×N})}εg_{MN}),M)┘Γ^{T}. (36)

Comparison of equation (29) with (36) and the above discussion immediately reveals that H_{Weich} and H_{PM} share the same artificial paths, but H_{Weich} uses only the energy of the artificial bidirectional paths without considering the fact that they are correlated. In the paper by Weischselberger et al. no attempt was made to show that the functions used constitute a basis and neither was the problem attacked from the point of view of random spaces; therefore, the study is unable to guarantee a predefined error in the approximation, in contrast to the model proposed herein. Furthermore, the simulation of the model in Weischselberger et al. uses all obtained one-way artificial paths, when they are not always required, because spatially correlated scenarios result in H restricted to a subspace. These differences emerge from the divergent model conception and utilization, as H_{PM} is a synthetic model while H_{Weich} was devised for the analysis of channel measurements.

Relation of the proposed model to the remaining models. The state-of-the-art models are expressed in a manner similar to (33), in the sense that they relate it to a matrix of propagating modes in the Tx end link F_{B} to a matrix containing the propagating modes in the Rx end link F_{A}, interacting through a matrix of coupling energies, Ω_{model}, as

H_{model}=F_{A}(^{□}Ω_{model}εG_{size})F_{B}^{T}; (37)

Where the meaning of ^{□}Ω_{model} and G_{size} is defined in (33), but with different possible matrix sizes. Note that this nomenclature of “A” for the end bond Rx and “B” for the end bond Tx has been used to maintain familiarity with Weischselberger et al. Also, the calculation of the coupling matrix is presented in a way that is similar to (35) but considering the Kronecker products of the one-way vectors used in the approximation. So defining F_{B⊗A}=F_{B} ⊗F_{A}, the statistics of the model weight coupling are obtained with:

F_{B⊗A}^{H}RₕF_{B⊗A}⇒R_{b,model}. (38)

However, all previous models have considered only the coupling energies, which results in

Ω_{model}=unvec(diag(R_{b,model}),J_{model}), (39)

where J_{model} is the number of functions used for approximation in the end-to-end link Rx.

Within this context, the matrices A and B have been considered as DPSS. These functions can be obtained through the proper decomposition of the following matrix

$${R}_{Prol} = \frac{sin [ {k}_{m} d ( s - t ) ]}{{k}_{m} d ( s - t )} , s , t = 0 , 1 , … T - 1 , \qquad ( 40 )$$

where S and t are enumerated variables and T is equal to N(M) for the case Tx(Rx). kₘ and d are the propagation on the end link in question. In V. Kontorovich, S. Primak, A. Alcocer-Ochoa and R. Parra-Michel, “MIMO channel orthogonalizations applying universal eigenbasis,” IET Signal Process., vol. 2, no. 2, pp. 87-96, 2008, the authors considered only the use of a subset K_{P} of all generated functions. This set fulfills the image condition {Rₕ}⊂ image {R_{h,1}}, by the fact that the Prolates kernel in the angle domain is given by a PAS^{Tx(Rx)} proportional to |cos(φ_{Tx(Rx)})_{|} (see details in [13]) for the same set of angular values considered in the proposed model; therefore, this model also represents a particular baseline solution of the methodology.

In the paper presented by Sayeed in A. M. Sayeed, “Deconstructing multiantenna fading channels,” IEEE Trans. Signal Process. vol. 50, no. 10, pp. 2563-2579, October 2002, the term “virtual channel representation” is coined, where the “virtual paths” are each of the vectors in the discrete Fourier transform (DFT) matrices F_{size}, of size equal to the number of antennas. Which means; F_{A}=F_{M×M}F_{B}=_{N×N}. This choice of vectors immediately implies that the selected functions are example points in (the discrete) wavenumber space. These selected functions are a basis of a channel M×N considering that F=F_{N×N}⊗F_{M×M}, and rank(F)=rank(F_{N×N})rank(F_{M×M}). Their relation to the proposed model can be derived from the fact that the DFT matrix represents a set of eigenvectors associated with the eigenvalues of a diagonal CCM matrix; thus its associated discrete wavenumber correlation matrix (WCM) is also diagonal. Therefore, it can be proved using the inverse Gans mapping that the associated angular PAS^{Tx(Rx)} for the end link of Tx(Rx) is proportional to |cos (φ_{Tx(Rx)})_{|} for the entire angle domain, and thus this model complies with {Rₕ}⊂ image {R_{h,1}} and represents a particular case of the proposed methodology. However, this approximation is opposed to any angular or wavenumber information, requiring the utilization of all involved artificial trajectories of M×N, which is not suitable for the reduced range approximation, even for the small angular spreads of the cross-PAS, due to the windowing effect of the limited size of the matrices, all functions have significant energies, and it is not possible to know in advance which combination of the basis functions contribute most of the energy.

Kronecker case: When the channel has separable cross-PAS, the CCM matrix satisfies (16), which is the condition to define the Kronecker model. This model can be used as an approximation for the non-separable cross-PAS channel, which is achieved by using (11), (15) and (16) to generate R_{h,sep}. Using the CCM eigenfunctions generated in this manner, the Kronecker model H_{Kron} expressed in terms of (37) is clearly

H_{Kron}=Φ_{J}(^{□}Ω_{Kron}⊗G_{J×I})Γₗ^{T}, (41)

where Ω_{Kron}=unvec(diag(Λ_{Tx} ⊗Λ_{Rx}),J) and Λ_{Tx(Rx)} is the eigenvalue matrix at the end link of Tx(Rx), as defined in the previous section. Comparing this model with H_{Weich} and H_{PM}, it becomes clear that only the statistics of the weights and the chosen number of basis functions differ, but the generated basis functions (artificial trajectories) are the same.

In all the studies mentioned above, the authors have considered that the weights of the basis functions are decorrelated. This consideration is unrealistic because the functions used, although they form a basis, are not proper functions of the CCM matrix in question. This consideration generates an error in their channel models when compared to the target channel, and avoided in H_{PM}, as will be clearly shown below.

### Relationship of the Proposed Model to Physical Models

Physical models can be represented as:

$${H}_{P h y s} = {\sum }_{k = 1}^{{K}_{δ}} {b}_{k} {v}_{Rx , k} {v}_{Tx , k}^{T} , \qquad ( 42 )$$

where bₖ weights are obtained by partitioning all trajectories in (4) into K_{δ} disjoint sets, and then integrating all physical trajectories belonging to the k-th set. Comparison of (42) with (27) reveals that this model is an approximation where the AMVs vectors are used as the artificial trajectories. This set of functions in general is not orthogonal, or a basis, but is easy to manipulate. Putting the AMV vectors together in a matrix according to V_{Tx(Rx),K}_{_{δ}}={v_{Tx(Rx),1}, V_{Tx(Rx),2}, . . . , v_{Tx(Rx),K}_{_{δ}}}; then the physical model reduces to

H_{Phys}=V_{Rx,K}_{_{δ}}(^{□}Ω_{Phys}εG_{K}_{_{δ}}_{×K}_{_{δ}})v_{Tx,K}_{_{δ}}^{T}, (43)

where ^{□}Ω_{Phys} is a diagonal matrix containing the square root elements of Ω_{Phys} and G_{K}_{_{δ}}_{×K}_{_{δ}} is in this case diagonal. The elements Ω_{Phys} are filled with {Ω_{Phys,k,k}}=ω_{k,k}=E{bₖbₖ*}. This approach is well known to deal only with channels with separable cross-PAS. Within this form of modeling, the number of random variables employed K_{δ} is considerably larger than MN, making the computation of (43) the most demanding of all the models previously discussed, without providing in a predefined way the error achieved in the approximation; therefore, this approximation is not considered in the other comparisons.

### Implementation of the Proposed Model

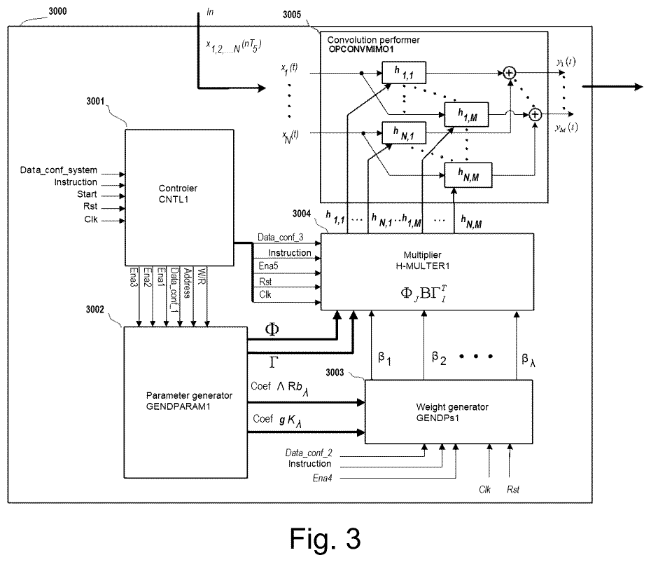

FIG. 3 shows the general architecture of the MIMO-type wireless channel simulator with non-separable Cross-PAS (3000) capable of reproducing channel simulations for MIMO schemes where the channel statistics to be simulated consider the spatial CCBBLE correlation.

The architecture consists of five essential blocks or modules (3001-3005) that together serve to generate simulations of H coefficients that spatially correlate the transmitted input signal x_{1,2, . . . ,N}(nTₛ) as shown in expression (1).

The simulator (3000) described in FIG. 3 comprises a controller module (3001) configured to perform the control of each of the remaining essential modules or blocks (3002 to 3005), said controller module (3001) corresponds to a finite state machine CNTL_1 that performs said control of each of the essential blocks that make up the architecture. Through a group of essential signals such as System_conf_data, Instruction, Start, Rst and Clk, it performs the parameter initialization processes required throughout the simulator modules (3000).

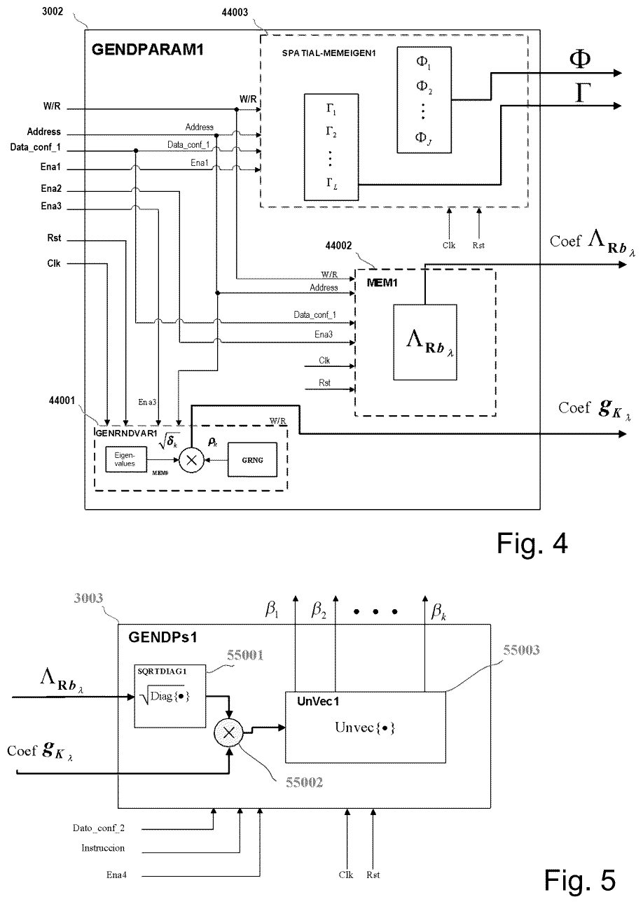

FIG. 4 illustrates in detail a coefficient generator module (3002) GENDPARAMI, configured to generate the coefficients CoefΛ_{Rb}_{_{λ}} and Coefg_{K}_{_{λ}}, as well as the base functions Φ and Γ, parameters that are required to perform the expansion of the H matrix which will spatially correlate the signal of interest x_{1,2, . . . ,N}(nTₛ). The coefficient generator module (3002) GENDPARAMI consists of a random variable generator module (44001) GENRNDVAR1, which produces random variables δₖ properly weighted by their corresponding weight ρₖ by multiplying the eigenvalues of the random variables with the corresponding weight ρₖ, thus generating the coefficient g_{K}_{_{λ}}. Likewise, the coefficient generator module (3002) comprises a coefficient storage and delivery sub-module (44002) MEM1 which stores and delivers the values of the parameters CoefΛ_{Rb}_{_{λ}}, as well as a base function storage and delivery sub-module (44003) SPATIAL-MEMEIGEN1 which stores and delivers the values of the base functions Φ and Γ. These coefficient and basis function parameters are required to perform the H matrix expansion.

FIG. 5 shows in detail how the weight generator module βₖ (3003) GENDPs1 is configured to generate the weights βₖ. by means of the coefficients CoefΛ_{Rb}_{_{λ}} and Coef g_{K}_{_{λ}} received from the coefficient generator module (3002). This module (3003) is conformed by an operation sub-module (55001) SQRTDIAG1 which performs a square root operation and rearrangement of the parameters CoefΛ_{Rb}_{_{λ}} to be later vectorially multiplied by means of a multiplier sub-module (55002) with the parameters Coef g_{K}_{_{λ}}. Once the multiplication is obtained, the result is transmitted to a coefficient ordering sub-module (55003) Unvec1 configured to rearrange the coefficients obtained, thus generating the weights βₖ.

Having obtained the weights βₖ by the weight generator module (3003) GENDPs1, the next step is to obtain the correlator matrix H by means of a correlator matrix module (3004) H-MULTER1. This module is configured to perform the expansion of the matrix H from the matrix multiplication of the basis functions Φ and Γ received from the coefficient generator module (3002) with the weights βₖ received from the weight generator module (3003).

Finally, the simulator (3000) comprises a convolution module (3005) OPCONVMIMO1 configured to perform a convolution of the input signal x_{1,2, . . . ,N}(nTₛ) with the H-channel matrix generated by the correlator matrix generator module (3004) H-MULTER1. Also, said convolution module (3005) OPCONVMIMO1 is additionally configured to add audible Gaussian white noise to the input signal once it was convolved with the H-channel matrix.

### Performance Analysis and Simulation Results

### Three Tests to Compare Models

MIMO channel models try to reproduce channel simulations according to a given CCM matrix. Therefore, it is mandatory to introduce a metric as the first test, based on the distance d₁(R_{Tar,N},^{□}R_{h,model,N}) between a target normalized CCM matrix defined as R_{Tar,N}, and the estimated normalized CCM matrix generated by the models defined as ^{□}R_{h,model,N}, Viewing these matrices as vectors in a space of dimension NM, a suitable metric is.

d₁(R_{Tar,N},^{□}R_{h,model,N})=|R_{Tar,N}−^{□}R_{h,model,N}|_{F}, (44)

where [symbol] _{F} is the Frobenius norm, defined as

$${‖ A ‖}_{F} = \sqrt{{\sum }_{m} {\sum }_{n} {\vert \{ {A}_{m , n} \} \vert}^{2}} . \qquad ( 45 )$$

For any CCM Rᵢ, R_{i,N} is the standardized version obtained with

$${R}_{i , N} = \frac{{R}_{i}}{{‖ {R}_{i} ‖}_{F}} .$$

Although this metric is sufficient for performance comparison, it is highly illustrative to visualize the cross-PAS reconstructed by the models, denoted as ^{□}P(φ_{Tx};φ_{Rx}), which represents the second test. For this purpose, the estimator of the spatial cross-correlation to the azimuthal power spectrum through the wavenumber spectrum (xSPAW) will be used. This tool provides an estimate of a cross-PAS from a given CCM array. When both ULAs arrays in the Tx and in the Rx are located along the ŷ axis, as in the case of the scenarios considered in this article, xSPAW is defined as

$${}^{▯} P ( {φ}_{Tx} ; {φ}_{R x} ) = \frac{{k}_{0}^{2} {d}_{T x} {d}_{R x}}{4 {π}^{2}} \times \vert cos ( {φ}_{T x} ) \vert \vert cos ( {φ}_{R x} ) \vert \frac{{v}^{H} ( {φ}_{Tx} ; {φ}_{R x} ) {R}_{h} v ( {φ}_{Tx} ; {φ}_{R x} )}{{v}^{H} ( {φ}_{Tx} ; {φ}_{R x} ) v ( {φ}_{Tx} ; {φ}_{R x} )} ; \qquad ( 46 )$$

where v(φ_{Tx};φ_{Rx})=v_{Tx}(φ_{Tx})⊗v_{Rx}(φ_{Rx}) and

v_{Tx}(φ_{Tx})=[1,e^{jk}^{₀}^{d}^{_{Tx}}^{sin(φ}^{_{Tx}}⁾, . . . ,e^{jk}^{₀}^{d}^{_{Tx}}^{(N-1)sin(φ}^{_{Tx}}⁾]^{T},

v_{Rx}(φ_{Rx})=,[1,e^{jk}^{₀}^{d}^{_{Rx}}^{sin(φ}^{_{Rx}}⁾, . . . ,e^{jk}^{₀}^{d}^{_{Rx}}^{(M-1)sin(φ}^{_{Rx}}⁾]^{T}. (47)

Once ^{□}P(φ_{Tx};φ_{Rx}) is obtained for a given model, it is normalized according to its Frobenius norm.

This third test consists of the comparison of the CDF of the channel capacity C, denoted as CDF(C) given by the models. Because the calculation of the channel capacity expression for this contribution is a problem beyond the scope of this invention, the capacity formula expressed as

$$C ( {H}_{model} ) = \{ {log}_{2} [ det ( {I}_{N} + \frac{S N R}{M} {H}_{model} {H}_{model}^{H} ) ] \} , \qquad ( 48 )$$

Where H_{model} corresponds to a channel simulation of the model used, with units given in bits/s/Hz. Once (48) is computed for a given model with a sufficient number of channel realizations, its CDF is obtained and used to compare the models. As discussed in detail in A. M. Sayeed, “Deconstructing multiantenna fading channels,” this measure is only an approximation for channels considered with general spatial correlation. However, it is helpful to show the trend of the models' capacity, and in connection with the reproduced cross-PAS, it provides insight into the available independent trajectories produced by the models.

### Definition of Channel Propagation for Model Robustness Analysis

To perform the performance comparison of the models, two channels representing two different propagation scenarios were selected, this will help to test the strengths of the compared models. The first propagation channel, defined as Channel I, illustrates a non-separable cross-PAS, composed of a sum of only three identifiable trajectories, defined as xPAS₁=σ₁²δ(φ_{Tx}−5°)δ(φ_{Rx}+18)+σ₂²δ(φ_{Tx}+4°)δ(φ_{Rx}+3)+σ₃²δ(φ_{Tx}−9°)δ(φ_{Rx}−7°), where σₙ²?=⅓ for. n=1,2,3.

The second propagation channel, defined as Channel II, is also a non-separable cross-PAS and represents a fuzzy propagation scenario. Channel II is composed of a sum of two separable cross-PASs, where the first separable cross-PAS is constructed from the outer product of two von Mises distributions, and the second from the outer product of uniform distributions, as follows:

$$x P A {S}_{2} = \frac{a}{{( 2 π {I}_{0} ( κ ) )}^{2}} {e}^{κ cos ( {φ}_{T x} + 10 ° )} {e}^{κ cos ( {φ}_{Rx} + 10 ° )} + {Π}_{20} ( {φ}_{T x} - 20 ° ) {Π}_{20} ( {φ}_{R x} - 20 ° ) ,$$

where κ=120, and the variable α is a constant selected to normalize the maximum amplitude of the von Mises distribution to unity, and I₀(•) is the modified Bessel function of the first type and 0-th order. Also, Π_{W}(•) is the pulse function, which has a unit amplitude for

$$- \frac{W}{2} \leq {φ}_{Tx ( Rx )} \leq \frac{W}{2} .$$

Note that the angular variables in these cross-PASs have been expressed in degrees to make it easier to write formulas and plot the results; however, it should be remembered that they must be converted to radians when any of the trigonometric functions need to be evaluated, such as when the AMVs are used. The angular domain resolution of these variables was set to one degree, although virtually the same simulation results are obtained at any finer resolution. Once both cross-PAS¹ and cross-PAS² were constructed, they were normalized to ensure that their full sum over both angular domains was one, i.e., to provide lossless channels. Of the defined scenarios, xCCM¹ and xCCM² were constructed from cross-PAS¹ and cross-PAS², respectively, with the help of equation (14) considering a system topology composed of ULAs arrays with eight antennas at each end of the link, with a separation between elements of λ/2 distance, and an operating frequency of 2 GHz. Likewise, the studies to be compared with the PM are: KLE expressed as in (41); the study defined as Sayeed; Weichselberger et al. abbreviated as Weich; the Kronecker approximation given in (41), abbreviated as Kron; and Kontorovich et al. abbreviated as Kont. For the case of the Kont model, the kernel of Prolates functions is constructed according to (40) as follows: considering the orientation of the matrices and the Gans mapping follows that

$${k}_{m} = {k}_{0} sin ( {φ}_{Tx ( Rx ) , Max} \frac{π}{180} ) ,$$

where φ_{Tx(Rx),Max} corresponds to the maximum angular spread in degrees for each end of the communication link, and for the considered channels, results in φ_{Tx,Max}=9° and φ_{Rx,Max} for cross-PAS¹ while φ_{Tx,Max}=31° and φ_{Rx,Max}=31° for cross-PAS².

### Performance Results

Once that the scenarios and tests have been defined, the performance of the models can be compared. With respect to the metric for CCM the distance comparison (first test), it is necessary to establish the CCM that the model reproduces, which can be obtained by means of an analytical formula that from simple manipulations of (38) results in

^{□}R_{h,model}=F_{B⊗A}R_{b,model}F_{B⊗A}^{H}. (49)

Likewise, the estimated CCM correlation matrix is also obtained by averaging the correlations obtained by the channel realizations coming from the models. Both versions of the generated matrices ^{□}R_{h,model} were first normalized and then compared with the (normalized) CCM matrix by means of the metric in the first test defined in (44), and whose results are presented in Table I for Channel I, and in Table II for Channel II. In these tables, the normalized Frobenius distance obtained theoretically (NFDT), represents the application of (44) with ^{□}R_{h,model} calculated using (49); the normalized Frobenius distance obtained for simulation (NFDS) uses R h,model calculated from averaging 10,000 channel realizations of the analyzed model. Base vectors once normalized to unity that are below 1×10⁻³ were discarded. Table I and Table II also present the number of required weights and the approximate CCMs matrix trace (tr), from which it can be seen that the selected modes have been chosen to have the most energy with the minimum number of basis functions (target matrix trace=NM=64). Finally, instead of using all the artificial trajectories as originally proposed by Sayeed and Weich, here only the most significant modes have been used, to provide a fair comparison with the proposed model; i.e., Sayeed and Weich's contributions would propose in this case 64 modes and thus 64 complex independent Gaussian generators. However, the error achieved is practically the same as that obtained when only the most important modes in the approximation are selected.

TABLE 1
Frobenius distance between a target CCM matrix
and the approximate CCM with the KLE, PM, Weich,
Sayeed, Kron and Kont models, for Channel I.

| Method | NFDT | NFDS | # ways | tr |
|---|---|---|---|---|
| KLE | 0 | 0.0190 | 3 | 64 |
| PM | 2e−15 | 0.0200 | 3 | 64 |
| Weich | 0.6299 | 0.6317 | 9 | 64 |
| Sayeed | 0.8525 | 0.8552 | 45 | 63.67 |
| Kron | 0.6684 | 0.6708 | 9 | 64 |
| Kont | 0.8182 | 0.8197 | 14 | 63.9057 |

TABLE 2
Frobenius distance between a target CCM matrix
and the CCM approximated with the KLE, PM, Weich,
Sayeed, Kron and Kont models, for Canal II.

| Method | NFDT | NFDS | # ways | tr |
|---|---|---|---|---|
| KLE | 0.0037 | 0.0221 | 16 | 63.7335 |
| PM | 0.0038 | 0.0267 | 16 | 63.7334 |
| Weich | 0.4600 | 0.4608 | 36 | 63.9922 |
| Sayeed | 0.6253 | 0.6268 | 46 | 63.6890 |
| Kron | 0.5424 | 0.5490 | 36 | 63.9922 |
| Kont | 0.9554 | 0.9588 | 33 | 63.8461 |

As can be seen from the results shown in the Tables, it is immediately clear that the previous models fail to reproduce the proposed channels; in fact, their performance is not far from the Kronecker model, and with respect to some models, the Kronecker model is even better. Making it clear that the maximum distance available in the considered metric is 2, it is clear that the previous models, aside from KLE, have a very considerable error. In contrast, the proposed model guarantees an error as low as desired with a complexity similar to KLE.

Comparing the KLE model with the proposed model shows that both models require the same number of Gaussian generators, well below the number of generators required by the remaining models, despite the large difference in their achieved errors. At the same time, the PM model requires eigen-decompositions of matrices that are smaller than those required by KLE so that less information is required to be stored, and hence there is a decrease in the complexity of the synthesis mode. To understand these points more clearly, consider for example the Channel I case. The direct application of KLE requires the realization of an eigen-composition of matrix size 64×64, while the proposed model only requires two eigen-decompositions of matrices of size 8×8 plus one of size 9×9. In the execution mode, the proposed model requires cross-correlation computation for artificial weights, which introduces more complexity than the KLE model entails, although the difference is negligible since this correlation matrix is generated at low rate of temporal fading. However, the most important advantage of the proposed model is that by expressing the channel as artificial paths from the transmitter to the receiver, it allows research in several fields, such as channel capacity calculation, beamforming and space-time coding, which the KLE model does not address since it hides the underlying antenna structure.

Comparing previous models with the proposed model of the present invention, it is immediately apparent that the invention is the only option for reproducing the target channel in terms of the error achieved. If the computational complexity is considered, it can be easily inferred that in synthesis mode, the proposed model, Weich and Kron are more complex than Sayeed and Kont, but they require less memory resources. However, in synthesis mode the proposed model is better than previous models because it requires fewer Gaussian generators, which are complex blocks. This property becomes even more relevant when frequency selectivity and time-varying scenarios are considered, in which each Gaussian generator should be replaced by a highly complex SISO generator (e.g., see [25]).

The main difference between the proposed model and the other models lies in the fact that the previous models neglect the importance of cross-correlation between spatial artificial trajectories. An example is presented in FIG. 2, where the modulus of each cell of the correlation matrix of artificial weights of the proposed model for Channel I is presented, denoted as |CMAW|, from which it can be concluded that the cross-correlation information is far from being close to zero, as previous models show.

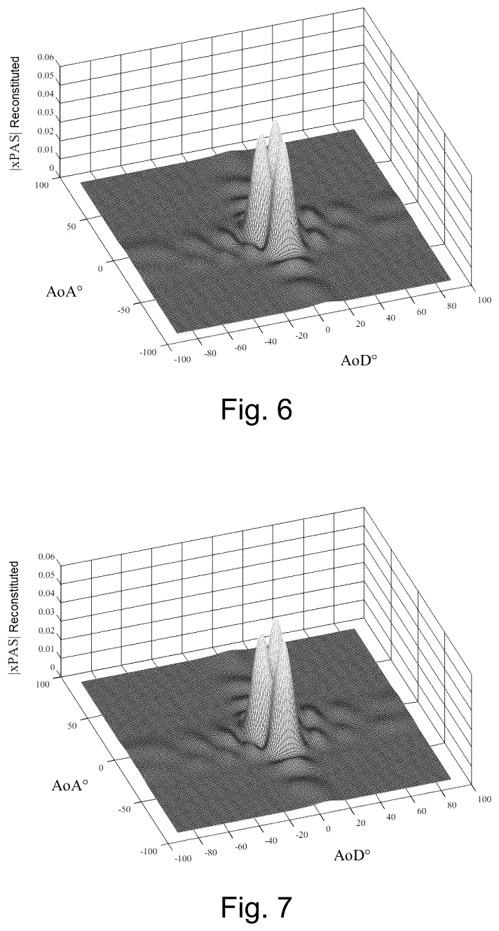

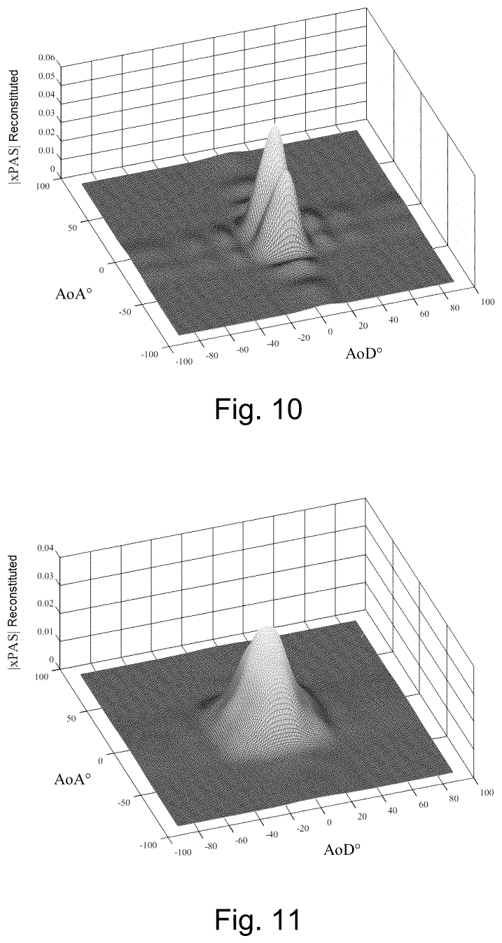

Results of the second test are now presented. The reconstructed cross-PAS is provided with (46) using the CCM produced by the model ^{□}R_{h,model}, obtained from (49). Once normalized, the moduli (of each value) of the reconstructed cross-PAS, defined as |xPAS|Reconstructed, are presented. The target result corresponds to the reconstructed |xPAS| of the original CCM of Channel I, and is shown in FIG. 6, while the results provided by the compared models are given in FIGS. 7 to 11.

Comparing the target result of the apparatus shown in FIG. 3 with FIG. 7, which shows the cross-PAS estimated with the proposed model, it is immediately apparent that the proposed model is able to reconstruct the original cross-PAS formed by three identifiable physical trajectories, limited only by the spatial resolution achieved by the small aperture of the array, which is 3.5λ. Note that the proposed model produces results that are virtually identical to those of the target channel. On the other hand, all other previous models erroneously created new trajectories and thus produce a cross-PAS very different from the target.

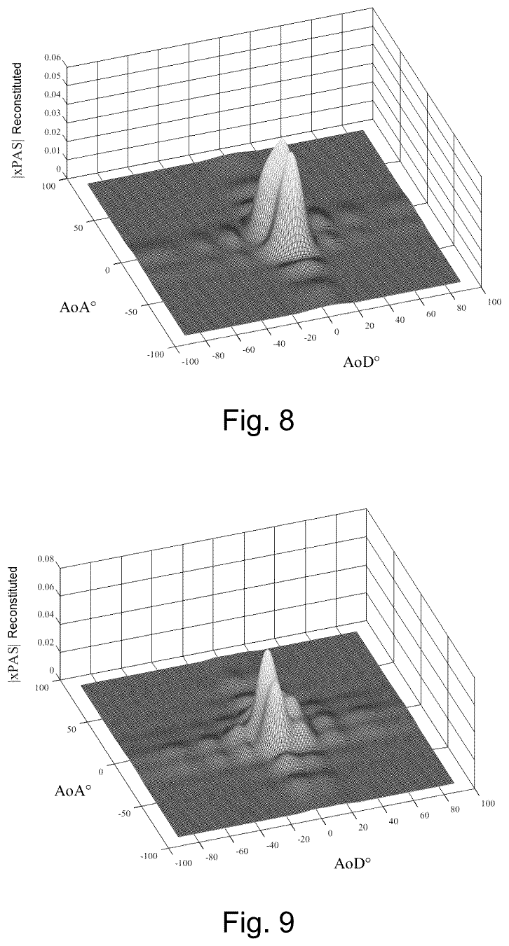

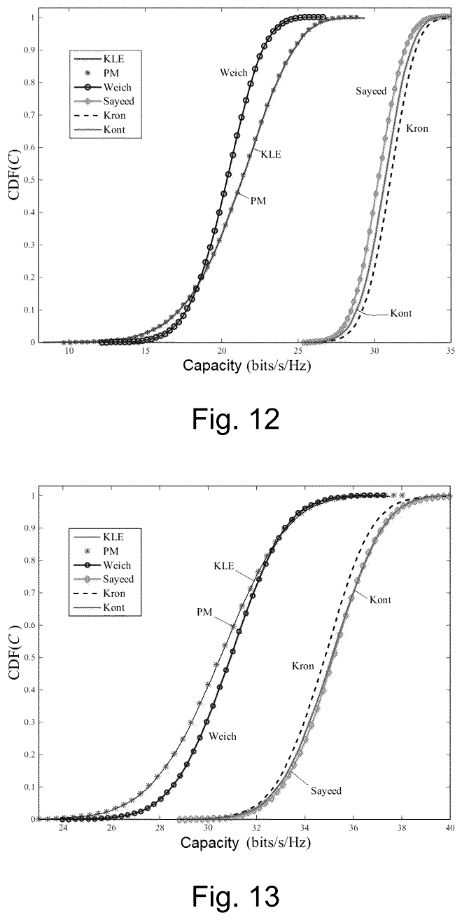

Finally, the cumulative distribution function of the channel capacity shown by the compared models is presented in FIGS. 12 and 13. These figures were obtained using (48) with 10,000 channel realizations or SNR=200. Although this calculation of the channel capacity is an approximation of the actual channel capacity, the only model capable of reproducing the statistical behavior of the actual channel is the PM. All the other models overestimated the channel capacity for the examples considered, except the Weich model, which appears to be not so far from the proposed model, although this model creates a different density function, it underestimates the capacity for Channel I while it overestimates the capacity for Channel II. But a closer look at the results, including the results in FIGS. 7 and 8, immediately produces large differences. For example, consider the cross-PAS of Channel I (which has three actual physical SISO channels) and the results presented in Table I. Once correlated by the finite antenna aperture, the 8×8 MIMO system still has three independent SISO channels, as is evident from the reconstructed cross-PAS and its KLE (or PM) eigenvalues. On the other hand, Weich creates nine independent channels, which is undesirable. This drawback is even more evident in the remaining models, where the creation of new artificial SISO channels introduce capacity and diversity that the real channel does not possess. In contrast, the proposed model is able to guarantee true independent channels offered by the propagation channel. Therefore, future research still needs to provide expressions for the calculation of channel capacity considering under non-separable cross-PAS channels, as well as novel algorithms that work optimally in these channels, for which the proposed methodology can be of help as a background due to its ability to reproduce the statistical behavior of the channel, in terms of unidirectional artificial paths.

The apparatus, methods and process schemes presented in this invention are provided merely as illustrative and non-limiting examples thereof, which represent the general principles of the invention, but are not necessarily intended to require or imply that the steps of the various definitions must be performed in the order presented. Other embodiments of the invention will be apparent to those skilled in the technical field from consideration of the present description. This application is designed to cover any variation, use or adaptation of the invention following the general principles of the invention and including such variations from the present description as are known or customary practice in the technical field.

The various illustrative blocks, modules and logic algorithms described in connection with the definitions described herein can be implemented in either hardware or software or combinations of both. To clearly illustrate this interchangeability of hardware and software, various illustrative components, blocks and modules have been described in terms of their functionality. The implementation of such functionality as hardware or software depends on the particular application and/or design constraints imposed by a system in general. Experts may implement the described functionality in various ways for each particular application, but such implementation decisions should not be construed as causing a departure from the scope of the present invention.

1. A MIMO-type wireless channel simulator exhibiting non-separable cross-PAS function comprising
a controller module (3001) configured to perform the control of each of the simulator modules;
a coefficient generator module (3002) configured to generate coefficients (CoefΛ_{Rb}_{_{λ}} and Coefg_{K}_{_{λ}}) and base functions (Φ and); Γ
a weight generator module βₖ (3003) configured to generate weights (βₖ) by means of the coefficients (CoefΛ_{Rb}_{_{λ}} and Coefg_{K}_{_{λ}}) received from the coefficient generator module (3002);
a correlator matrix generator module (3004) configured to perform the expansion of a matrix (H) from the matrix multiplication of the basis functions (Φ and Γ) received from the coefficient generator module (3002) with the weights (βₖ) received from the weight generator module (3003); and
a convolution module (3005) configured to perform a convolution of the input signal x_{1,2, . . . ,N}(nTₛ) with the channel matrix (H) generated by the correlator matrix generator module (3004).

2. A MIMO-type wireless channel simulator exhibiting non-separable cross-PAS function according to claim 1, wherein the controller module (3001) is a finite state machine.

3. A MIMO-type wireless channel simulator exhibiting non-separable cross-PAS function according to claim 1, wherein the coefficient generator module (3002) further comprises a random variable generator sub-module (44001), a coefficient storage and delivery sub-module (44002) and a base function storage and delivery sub-module (44003).

4. A MIMO-type wireless channel simulator exhibiting non-separable cross-PAS function according to claim 3, wherein the random variable generator sub-module (44001), is configured to generate random variables that are weighted by a corresponding weight (ρₖ) by a multiplication of eigenvalues of the random variables with said corresponding weight (ρₖ), for the generation of the coefficient g_{K}_{_{λ}}, and configured to deliver said coefficient g_{K}_{_{λ}} to the weight generator module (3003).

5. A MIMO-type wireless channel simulator exhibiting non-separable cross-PAS function according to claim 3, wherein the coefficient storage and delivery sub-module (44002) is configured to provide the coefficient Λ_{Rb}_{_{λ}} to the weight generator module (3003).

6. A MIMO-type wireless channel simulator exhibiting non-separable cross-PAS function according to claim 3, wherein the base function storage and delivery sub-module (44003) is configured to provide the base functions Φ and Γ to the weight generator module (3003).

7. A MIMO-type wireless channel simulator exhibiting non-separable cross-PAS function according to claim 1, wherein the weight generator module βₖ (3003) is additionally configured to
perform a square root operation and rearrange the parameters of CoefΛ_{Rb}_{_{λ}} by means of an operation sub-module (55001);
multiply the result of the square root with the parameters of Coef g_{K}_{_{λ}} by means of a multiplication sub-module (55002);
transmit the result of such multiplication to a coefficient ordering sub-module (55003) which is configured to generate a rearrangement of the obtained coefficients, thus generating the weights βₓ; and
transmit these weights βₓ to the correlator matrix generator module (3004).

8. A MIMO-type wireless channel simulator exhibiting non-separable cross-PAS function according to claim 1, wherein the convolution module (3005) is further configured to add audible Gaussian white noise to the input signal once it was convolved with the channel matrix (H).

9. A method of simulating MIMO-type wireless channels exhibiting non-separable cross-PAS function, characterized in that it comprises the steps of:
generate coefficients (CoefΛ_{Rb}_{_{λ}} and Coef_{K}_{_{λ}}) and basis functions (Φ and Γ) by means of a coefficient generator module (3002);
generate weights (βₖ) from the coefficients (CoefΛ_{Rb}_{_{λ}} and Coef); g_{K}_{_{λ}}
to perform the expansion of a matrix (H) from the matrix multiplication of the basis functions (Φ and Γ) received from the coefficient generator module (3002) with the weights (ρₖ) received from the weight generator module (3003); and
convolve the input signal x_{1,2, . . . ,N}(nTₛ) with the expanded channel matrix (H).

10. The method of simulating MIMO-type wireless channels exhibiting non-separable cross-PAS function according to claim 9, wherein the step of generating coefficients (Coef Λ_{Rb}_{_{λ}} and Coefg_{K}_{_{λ}}) and basis functions (Φ and Γ) additionally comprises the step of generating random variables that are weighted by a corresponding weight (ρₖ) by a multiplication of eigenvalues of the random variables with said corresponding weight (ρₖ), for the generation of the coefficient (g_{K}_{_{λ}}).

11. The method of simulating MIMO-type wireless channels exhibiting non-separable cross-PAS function according to claim 9, wherein generating weights (βₖ) further comprises the steps of.
perform a square root operation and rearrange the parameters of CoefΛ_{Rb}_{_{λ}};
multiply the result of the square root with the parameters of Coefg_{K}_{_{λ}};
generate a rearrangement of the coefficients obtained from the result of such multiplication, and thus generate the weights βₖ.

12. The method of simulating MIMO-type wireless channels exhibiting non-separable cross-PAS function according to claim 9, wherein the step of convolving the input signal x_{1,2, . . . ,N}(nTₛ) with the expanded channel matrix (H) further comprises the step of adding audible Gaussian white noise to the input signal once it was convolved with the channel matrix (H).
